(19) United States
(12) Patent Application Publication
(10) Pub. No.: US 2006/0266830 A1
(43) Pub. Date: Nov. 30, 2006

(54) Location-based recommendation system

(76) Inventors: Tzvetan T. Horozov, Hoffman Estates, IL (US); Nitya Narasimhan, Schaumburg, IL (US); Venugopal Vasudevan, Palatine, IL (US)

Correspondence Address: MOTOROLA, INC., 1303 EAST ALGONQUIN ROAD, IL01/3RD, SCHAUMBURG, IL, 60196, US

(21) Appl. No.: 11/141,121

(22) Filed: May 31, 2005

(51) Int. Cl. G07C 13/00

(52) U.S. Cl. 235/386; 705/12; 709/205; 235/462.03

(57) ABSTRACT

A memory-based collaborative filtering algorithm is optimized for large numbers of users by employing a personalized location-based data partitioning method that allows the system to scale even for very large datasets. Collaborative filtering then takes place on the scaled dataset.

### FIELD OF THE INVENTION

The present invention relates generally to recommendation systems and in particular to a location-based recommendation system.

### BACKGROUND OF THE INVENTION

Recommender systems have been an active area of research since the advent of e-commerce. Such systems basically work by establishing a correlation between users based on their voting pattern. Users having similar likes are used to recommend products/services to each other.

Various companies have shown that a retail experience can be substantially enhanced by statistically correlating macro patterns in buying and browsing behavior. However, the usage of recommender systems in e-commerce is likely to differ substantially from the requirements of similar systems in mobile environments. For example, unlike infrastructure systems that always recommends the highest scoring items, location-based recommender systems recommend items that have the highest score and at the same time are located in the vicinity of a mobile user. Such difference introduces additional computational restriction, which prevents the usage of otherwise scalable item-based collaborative filtering (CF) algorithms and makes them impractical. A possible solution is to resort to user-based (memory-based) collaborative filtering algorithms. The problem however with user-based collaborative filtering algorithms is that they do not scale well and can not provide a real-time prediction, when the voting dataset increases to potentially tens of millions of users and items. Because of this, a need exists for a location-based recommendation system that can deal with the large amount of users and items found within mobile environments.

### BRIEF DESCRIPTION OF THE DRAWINGS

FIG. 1 is a block diagram of a recommender system.

FIG. 2 is a flow chart showing operation of the recommender system of FIG. 1.

FIG. 3 is a flow chart showing operation of the filtering module of FIG. 1.

### DETAILED DESCRIPTION OF THE DRAWINGS

To address the above-mentioned need a method and apparatus for recommending items/services to mobile users is provided herein. More particularly, a memory-based collaborative filtering algorithm is optimized for large numbers of users by employing a personalized location-based data partitioning method that allows the system to scale even for very large datasets. Collaborative filtering then takes place on the scaled dataset.

Because the pool of potential users is filtered prior to collaborative filtering, the population of Points of Interest and their votes is greatly reduced prior to collaborative filtering. This allows for potential real-time recommendations to users within mobile and non-mobile environments where large user populations exist.

The present invention encompasses a method for performing a location-based recommendation. The method comprises the steps of determining a home location of a user, determining points of interest having been voted on by users living near the home location of the user, and performing collaborative filtering on the points of interest having been voted on by users living near the home location of the user. The user is then provided a recommendation based on the collaborative filtering of the points of interest having been voted on by users living near the home location of the user.

The present invention additionally encompasses a method for performing a location-based recommendation. The method comprises the steps of determining a home location of a user, determining a current location of the user, determining points of interest near the current location of the user having been voted on by users living near the home location of the user, and performing collaborative filtering on the points of interest near the current location of the user having been voted on by users living near the home location of the user. The user is provided a recommendation based on the collaborative filtering of the points of interest near the current location of the user having been voted on by users living near the home location of the user.

Finally, the present invention encompasses an apparatus comprising a database comprising a home location of a user, a database comprising points of interest, a filtering module accessing the databases and outputting points of interest having been voted on by users living near the home location of the user, and a collaborative filter receiving the points of interest and performing collaborative filtering on the points of interest, outputting a user recommendation based on the collaborative filtering.

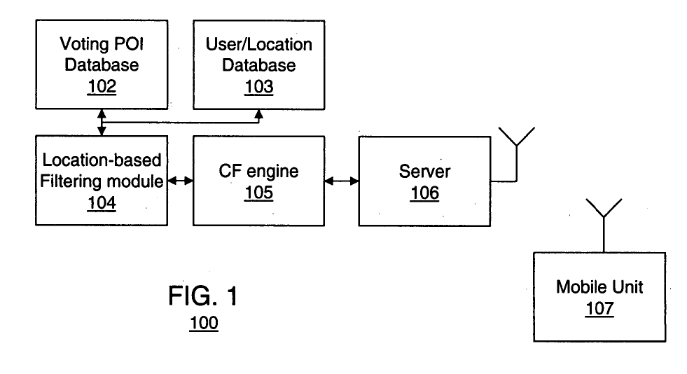

Turning now to the drawings, wherein like numerals designate like components, FIG. 1 shows a block diagram of a recommender system 100. As shown system 100 comprises server 106 and mobile unit 107. In the preferred embodiment of the present invention, server 106 and mobile unit 107 comprise a standard cellular base station 106 and handset 107, however in alternate embodiments of the present invention server 106 and mobile unit 107 may take other forms. For example, server 106 and mobile unit 107 may simply comprise a server 106 and computer 107 connected either wirelessly or wired. Regardless of the form that server 106 and mobile unit 107 take, system 100 comprises context filtering (CF) engine 105, location-based filtering module 104, voting point-of-interest (POI) database 102, and user/location database 103.

During operation a recommendation on a particular product or service is to be provided to a user. For example, a user operating mobile unit 107 may wish to receive a recommendation for a Chinese restaurant close to the user's current location, or may wish to receive a recommendation for a book store close to the user's current location. Regardless of the recommendation, mobile unit 107 will transmit this request to server 106. The request will comprise a particular item or service requested along with the user's identification and the user's current location. Server 106 will receive the request and utilize CF engine 105 in order to obtain recommendations for mobile unit 107.

In the preferred embodiment of the present invention the current location is provided to server 106 by mobile unit 107 providing a zip code, however in alternate embodiments of the present invention the current location may comprise an area code, a geographic location, . . . etc. Additionally, while in the preferred embodiment of the present invention the current location is provided to server 106 by mobile unit 107, in alternate embodiments of the present invention, server 106 may determine the location of mobile unit 107 via standard cellular telephone location techniques (e.g., GPS, triangulation, . . . etc.).

As discussed above, the enormous size of the points of interest and their votes makes a real-time user-based recommendation system difficult to achieve. Thus, recommender system 100 must scale to populations potentially numbering in the multi-millions so that real-time recommendations can be made to users. At the same time, only relevant users and their votes must be selected so that the system can maintain its prediction capability. In order to accomplish this task, location-based filtering module 104 is employed to provide CF engine 105 a filtered set of points of interest and their votes so that user-based collaborative filtering may be employed on the minimized user set. CF engine 105 employs traditional user-based collaborative filtering techniques on the filtered set of users and provides server 106 with recommendations.

The general idea behind collaborative filtering is that similar users vote similarly on similar items. Therefore, if similarity is determined between users and items, a potential prediction can be made for the vote of a user for some item. In the preferred embodiment of the present invention, using a standard user-based collaborative filtering algorithm, users are identified as similar if they have voted similarly on the same item. However, because users who live in the same area are likely to go to the same places and vote on the same location-based items, the entire user population need not be considered to find similar users. Only those points of interest voted on by users who live in a same location as the current user may be considered in order to save processing. For example, only those points of interest voted on by users within the same zip code or area code of the current user may be considered, or alternatively only those points of interest voted on by users within a predetermined radius of the user's home location may be considered.

With the above in mind, filtering module 104 filters available data by supplying only points of interest (POIs) and voting results to CF engine 105 for points of interest voted on by users sharing a similar home location (e.g., similar zip code, area code, geographic location . . . etc.). Thus, no matter where a user operating mobile unit 107 currently resides, recommendations will be provided to mobile unit 107 based on collaborative filtering of points of interest voted on by users residing near user's home location.

Filtering module 104 works as follows: Database 103 comprises home locations for all users and POI database 102 comprises points of interests voted on by all users and their votes. For a current user, user/location database 103 is accessed to determine individuals sharing the same home location as the current user. Once the set of users sharing a same home location is determined, voting POI database 102 is accessed by module 104 to determine a POI set (users, POIs, and corresponding votes on the POIs) that had votes cast by the set of users sharing the same home location. The POI set can further be reduced to contain only users, POIs, and their corresponding votes by eliminating users, POIs, and their corresponding votes that have not cast at least one vote in the vicinity of the current location of the mobile user. The POI set and their votes are supplied to CF engine 105.

CF engine 105 receives the POI set and their votes. For a current user location, CF engine 105 determines POIs from the POI set that are within a certain user-defined radius of its current location. A user prediction is made on each of the POIs from the POI set based on a standard user-based collaborative filtering techniques. More particularly, a similarity coefficient (Pearson coefficient as known in the prior art) is determined between each of the users in the dataset with respect to the current user. For every POI in the vicinity of the user, the most similar users who have voted on that POI are selected. Based on the votes of those users for the given POI and their similarity to the current uses, a prediction is computed for that POI. The POI with the highest predictions is recommended to the user.

It should be noted that there may exist situations where there are no POIs from the POI set that are within the user-defined radius. In that situation CF engine 105 will resort to other non collaborative filtering recommendation techniques such as user-average prediction (predict the POI that have the highest average vote, based on all users who have rated it, regardless of their home location).

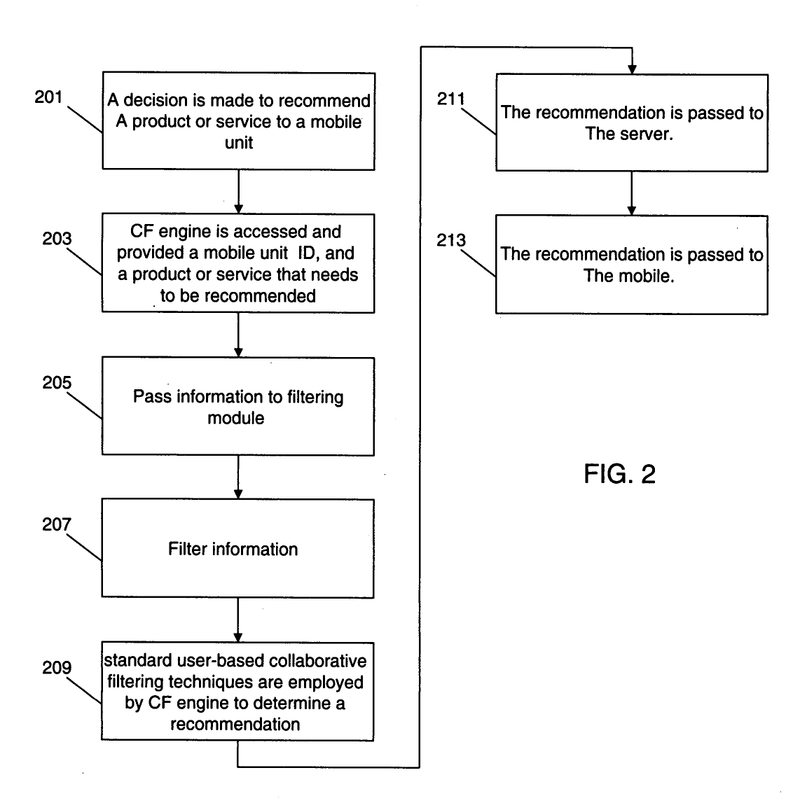

FIG. 2 is a flow chart showing operation of recommender system 100 of FIG. 1. The logic flow begins at step 201 where server 106 makes a decision to recommend a product/service to mobile unit 107. The decision to recommend a product/service to mobile unit 107 may be in response to mobile unit 107 requesting such a recommendation, or alternatively, may be in response to other triggers (e.g., other inquiries by mobile unit 107, a change in location for mobile unit 107, . . . , etc.).

Regardless of the reason for providing a recommendation to mobile unit 107, when server 106 decides to provide a recommendation to mobile unit 107, the logic flow continues to step 203 where CF engine 105 is accessed and provided a mobile unit identification (ID), a product or service that needs to be recommended, and a current user location. The current user location may be directly obtained from mobile unit 107 by, for example, mobile unit 107 providing a zip code, area code, or geographic coordinates. Alternatively, server 106 may determine the location by standard triangulation techniques commonly employed in cellular telephone systems to determine a user's location.

Once the mobile ID, current location, and product/service request is received, CF engine 105 passes this information to filtering module 104 (step 205). In response, filtering module 104 provides CF engine 105 with a filtered set of POIs and their votes for POIs near a current location of mobile unit 107 (step 207). As discussed, this is accomplished by filtering module 104 accessing location database 103 to obtain a home location for mobile unit 107 (i.e., a home location for the user of mobile unit 107). A set of users sharing a same home location (i.e., within a predetermined radius of the user's home, sharing a same zip code, sharing a same area code) is determined and voting POI database 102 is accessed by module 104 to determine a POI set that had votes cast by the set of users sharing the same home location. To further reduce the data passed to CF engine 105, the data is further filtered by module 104 by providing CF engine 105 only users (and their POI votes) who have cast votes in the vicinity of the current location of the mobile user. In the preferred embodiment of the present invention this is accomplished by providing CF engine 105 only POIs and their votes that are in the same area code as the current location of the user. However, in alternate embodiments of the present invention the data can be further filtered by providing users and their POI votes who have cast votes for POIs in a same zip code or geographic location.

Continuing, once CF engine 105 receives the filtered set of users and their POI votes, standard user-based collaborative filtering techniques are employed by CF engine 105 to determine a recommendation(s) at step 209. The recommendation is passed to server 106 at step 211 and finally to mobile unit 107 at step 213.

As discussed above, because CF engine 105 need only determine a recommendation from a limited set of data, real-time recommendations may be made to mobile unit 107.

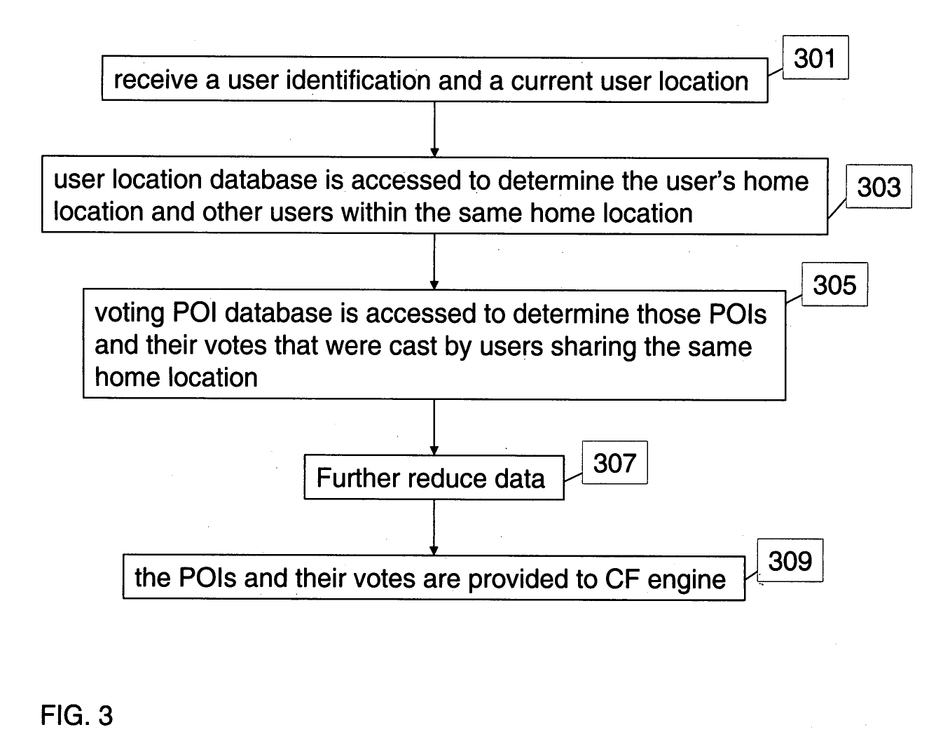

FIG. 3 is a flow chart showing operation of filtering module 104. The logic flow begins at step 301 where filtering module 104 receives a user identification and a current user location. At step 303 user location database 103 is accessed to determine the user's home location and other users within the same home location. At step 305 voting POI database is accessed to determine those POIs and their votes that were cast by users sharing the same home location. Filtering module 104 may further reduce the data set provided to CF engine 105, by determining those POIs that are near the user's current location (step 307). Finally, at step 309 the POIs and their votes are provided to CF engine 105. As is evident, all POIs (and their votes) provided to engine 105 will have the following in common:

All POIs will be voted on by users within a same home location; and

All POIs will be within a user's current location.

While the invention has been particularly shown and described with reference to a particular embodiment, it will be understood by those skilled in the art that various changes in form and details may be made therein without departing from the spirit and scope of the invention. For example, although recommendation system 100 is shown existing within a mobile/wireless environment, one of ordinary skill in the art will recognize that the recommendation system described above may be employed in any mobile/non-mobile/wireless/non-wireless environment. It is intended that such changes come within the scope of the following claims.

1. A method for providing a location-based recommendation, the method comprising the steps of:
determining a home location of a user;
determining points of interest having been voted on by users living near the home location of the user;
performing collaborative filtering on the points of interest having been voted on by users living near the home location of the user; and
providing the user a recommendation based on the collaborative filtering of the points of interest having been voted on by users living near the home location of the user.

2. The method of claim 1 further comprising the step of:
determining a current location of the user;
wherein the step of determining points of interest further comprises the step of determining points of interest that are located in a vicinity of the current location of the user; and
wherein the step of performing collaborative filtering comprises the step performing collaborative filtering on the points of interest having been voted on by users living near the home location of the user and that are located in the vicinity of the current location of the user.

3. The method of claim 2 wherein the step of determining the current location comprises the step of determining a zip code.

4. The method of claim 2 wherein the step of determining the current location comprises the step of determining an area code.

5. The method of claim 2 wherein the step of determining the current location comprises the step of determining geographic coordinates.

6. The method of claim 1 wherein the step of determining points of interest having been voted on by users living near the home location of the user comprises the step of determining points of interest having been voted on by users living within a predetermined radius of the home location.

7. The method of claim 1 wherein the step of performing collaborative filtering comprises the step of performing user-based context filtering.

8. The method of claim 1 wherein the step of determining the home location of the user comprises the step of determining a home zip code of the user.

9. The method of claim 1 wherein the step of determining the home location of the user comprises the step of determining a home area code of the user.

10. The method of claim 1 wherein the step of determining the home location of the user comprises the step of determining a home geographic location of the user.

11. A method for providing a location-based recommendation, the method comprising the steps of:
determining a home location of a user;
determining a current location of the user;
determining points of interest near the current location of the user having been voted on by users living near the home location of the user;
performing collaborative filtering on the points of interest near the current location of the user having been voted on by users living near the home location of the user; and
providing the user a recommendation based on the collaborative filtering of the points of interest near the current location of the user having been voted on by users living near the home location of the user.

12. The method of claim 11 wherein the step of determining the current location comprises the step of determining a zip code.

13. The method of claim 11 wherein the step of determining the current location comprises the step of determining an area code.

14. The method of claim 11 wherein the step of determining the current location comprises the step of determining geographic coordinates.

15. The method of claim 11 wherein the step of performing collaborative filtering comprises the step of performing user-based context filtering.

16. The method of claim 11 wherein the step of determining the home location of the user comprises the step of determining a home zip code of the user.

17. The method of claim 11 wherein the step of determining the home location of the user comprises the step of determining a home area code of the user.

18. The method of claim 11 wherein the step of determining the home location of the user comprises the step of determining a home geographic location of the user.

19. An apparatus comprising:
a database comprising a home location of a user;
a database comprising points of interest;
a filtering module accessing the databases and outputting points of interest having been voted on by users living near the home location of the user; and
a collaborative filter receiving the points of interest and performing collaborative filtering on the points of interest, outputting a user recommendation based on the collaborative filtering.

20. The apparatus of claim 19 wherein the filtering module outputs points of interest having been voted on by users living near the home location of the user and are additionally located in a vicinity of the current location of the user.
